(19) United States
(12) Patent Application Publication
(10) Pub. No.: US 2012/0168622 A1
(43) Pub. Date: Jul. 5, 2012

(54) SYSTEM AND METHOD FOR PRODUCING A MASS ANALYZED ION BEAM

(75) Inventors: Victor M. Benveniste, Lyle, WA (US); Frank Sinclair, Quincy, MA (US); Svetlana Radovanov, Marblehead, MA (US); Bon-Woong Koo, Andover, MA (US)

(73) Assignee: VARIAN SEMICONDUCTOR EQUIPMENT ASSOCIATES, INC., Gloucester, MA (US)

(21) Appl. No.: 12/981,002

(22) Filed: Dec. 29, 2010

(51) Int. Cl. H01J 49/30

(52) U.S. Cl. 250/298; 250/492.3

(57) ABSTRACT

An implantation system includes an ion extraction plate having a set of apertures configured to extract ions from an ion source to form a plurality of beamlets. A magnetic analyzer is configured to provide a magnetic field to deflect ions in the beamlets in a first direction that is generally perpendicular to a principle axis of the beamlets. A mass analysis plate includes a set of apertures wherein first ion species having a first mass/charge ratio are transmitted through the mass analysis plate and second ion species having a second mass/charge ratio are blocked by the mass analysis plate. A workpiece holder is configured to move with respect to the mass analysis plate in a second direction perpendicular to the first direction, wherein a pattern of ions transmitted through the mass analysis plate forms a continuous ion beam current along the first direction at the substrate.

### FIELD

The present disclosure relates to ion beams. More particularly, the present disclosure relates to producing a mass analyzed ion beam within ion implantation systems.

### BACKGROUND

For many applications, such as formation of solar cells using ion implantation, the ability to implant at high current in an efficient manner is needed to reduce production costs. Large area sources may have various configurations.

Known beamline implanters may include an ion source, extraction electrodes, a mass analyzer magnet, corrector magnets, and deceleration stages, among other components. The beamline architecture provides a mass analyzed beam such that ions of a desired species are conducted to the substrate (workpiece). However, one disadvantage of the beamline implanter architecture is that the implantation current and therefore the throughput may be insufficient for economical production in applications such as implantation of solar cells.

Plasma doping tools (PLAD) may provide a more compact design that is capable of producing higher beam currents at a substrate. In a PLAD tool, a substrate may be immersed in a plasma and provided with a bias with respect to the substrate to define the ion implantation energy. However, PLAD system designs suffer from the fact that a mass analysis capability does not exist, thereby preventing the screening of ions of undesirable mass from impinging on the substrate.

It will therefore be apparent that a need exist to improve ion implanter architecture, especially in the case of high throughput large ion beams.

### SUMMARY

Embodiments of the present disclosure are directed to implanters that include a large area ion extraction system and a single-magnet configuration that produce a mass resolution for ion beams incident on a workpiece. In accordance with one embodiment, a system for producing a mass analyzed ion beam for implanting into a workpiece includes an ion extraction plate having a set of apertures configured to extract ions from an ion source to form a plurality of beamlets. The system also includes a magnetic analyzer configured to provide a magnetic field to deflect ions in the beamlets in a first direction that is generally perpendicular to a principle axis of the beamlets and a mass analysis plate having a set of apertures wherein first ion species having a first mass/charge ratio are transmitted through the mass analysis plate and second ion species having a second mass/charge ratio are blocked by the mass analysis plate. A workpiece holder is configured to move with respect to the mass analysis plate in a second direction perpendicular to the first direction, wherein a pattern of ions transmitted through the mass analysis plate forms a continuous ion beam current along the first direction at the substrate.

In another embodiment, a method of providing a large area mass analyzed ion beam to a substrate includes forming unanalyzed beamlets that define a beam footprint having a long axis, said beamlets formed by extracting ions from an ion source through a plurality of slots in an extraction plate. The method further includes deflecting a first and second group of ions in the unanalyzed beamlets over respective first and a second deflection distances in a first direction generally parallel to the long axis of the beam footprint with a magnetic field, and blocking the second group of ions with an analysis plate. The method also includes translating the substrate with respect to the analysis plate in a second direction perpendicular to the first direction, wherein a pattern of ions transmitted through the analysis plate forms a continuous ion beam current along the first direction at the substrate.

### BRIEF DESCRIPTION OF THE DRAWINGS

For a better understanding of the present disclosure, reference is made to the accompanying drawings, which are incorporated herein by reference and in which:

FIGS. 1 and 2 present a top plan and side plan view, respectively, of features of an exemplary implantation system;

FIGS. 3 and 4 present a side plan view of exemplary aperture arrangements;

FIG. 5 is a graph that depicts calculated ion trajectories in a magnetic field as a function of ion species;

FIGS. 6a and 6b present a side plan view and top cross-sectional view, respectively, of an exemplary arrangement of extraction and mass analysis plates;

FIG. 6c presents a top cross-sectional view of another exemplary arrangement of extraction and mass analysis plates.

FIGS. 7a and 7b depict side plan views of alternative exemplary magnetic analyzers;

FIG. 8 depicts an exemplary dithering magnet in side plan view;

FIG. 9a depicts a side plan view of exemplary mass analyzed beamlets;

FIGS. 9b and 9c depict respective ion current profiles from beamlets transmitted to a workpiece in the absence of a dithering magnet under overlap and underlap conditions, respectively; and

FIG. 9d depicts an ion current profile from beamlets transmitted to a workpiece in the presence of a dithering magnet.

### DETAILED DESCRIPTION

The present invention will now be described more fully hereinafter with reference to the accompanying drawings, in which embodiments of the invention are shown. This invention, however, may be embodied in many different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout.

In the description and figures to follow a set of Cartesian coordinate system is consistently used to define and describe the operation of embodiments.

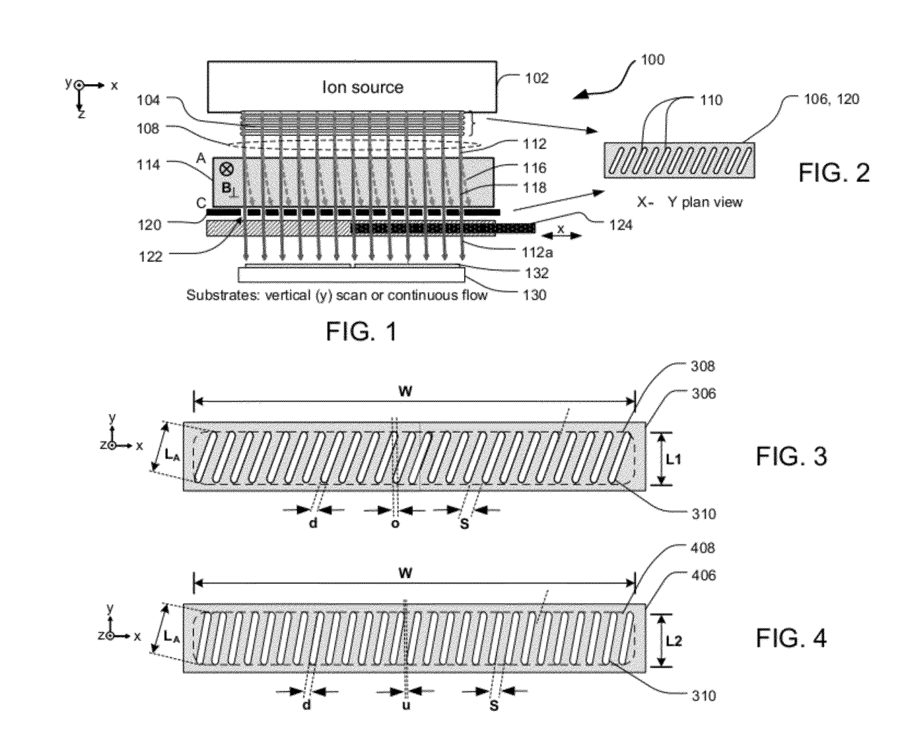

FIG. 1 presents a schematic plan view of an exemplary ion implanter 100. This ion implantation system employs a large area ion source 102, which may be one of many designs as known in the art. An extraction assembly 104 may be disposed along one side of the ion source. The extraction assembly may have one or more aperture plates 106 arranged in serial fashion to extract an ion beam 108 from ion source 102. Each extraction plate may be provided with a plurality of elongated slots 110 (or “apertures”) that have a high aspect ratio. In some embodiments, the aperture length dimension L_{A} may be about two or more times greater than the aperture width d, as depicted in FIG. 2. The slots may be arranged with their long axes parallel to each other as also depicted in the side plan view of FIG. 2. The slots 110 may also be mutually arranged in side-by-side fashion, for example, as shown in FIG. 2. Accordingly, the slots may produce a plurality of beamlets 112 that are transmitted through the extraction assembly and pass through a magnet assembly 114.

Magnet assembly 114 may include magnets that are arranged to produce a moderate dipole magnetic field that is configured to produce an orthogonal force on a passing charged particle. When beamlets 112 pass through the magnet assembly, ions within the beamlets may experience a deflecting force that acts to deflect lighter ions 116 a greater lateral distance from their initial trajectories than the deflection imparted to heavier ions 118, which may travel in a substantially straighter trajectory as shown. As used herein, the terms “lighter ions” and “heavier ions” generally refer to ions having relatively smaller mass/charge ratios and those ions having relatively larger mass/charge ratios, respectively.

System 100 also includes a screening plate 120 that include apertures 122, which may be configured to pass ions 118. Apertures 122 may also be configured to block ions 116, whose trajectories are more curved, resulting in a displacement that causes their trajectories to intercept the screening plate 120. Accordingly, screening plate 120 may produce a series of beamlets 112a that are mass analyzed beamlets, wherein the beamlets 112a have a larger fraction of the straighter-trajectory ions (which may be heavier ions). As depicted in FIG. 2, in some embodiments screening plate 120 may be configured similarly to aperture plate 106.

As viewed in FIG. 1, the workpiece (substrate) holder 130 may be arranged under screening plate 120 to intercept those ions that are extracted from ion source 102 and conducted in generally straight trajectories to workpieces 132. In one example, in operation, a plasma (not shown) within ion source 102 may be biased with respect to the workpiece holder 130 in accordance with a desired ion implantation energy. The workpiece holder 130 may also be configured to scan workpieces 132 in the y-direction with respect to ion source 102. The workpiece holder 132 may additionally be configured to continually flow in the y-direction.

As depicted in FIG. 2 and discussed further below with respect to FIGS. 3 and 4, the extraction slots 110 (as well as mass analysis slots 122) may be provided at an angle with respect to the y-direction to facilitate forming a continuous current across a workpiece when the workpiece is scanned in the y-direction.

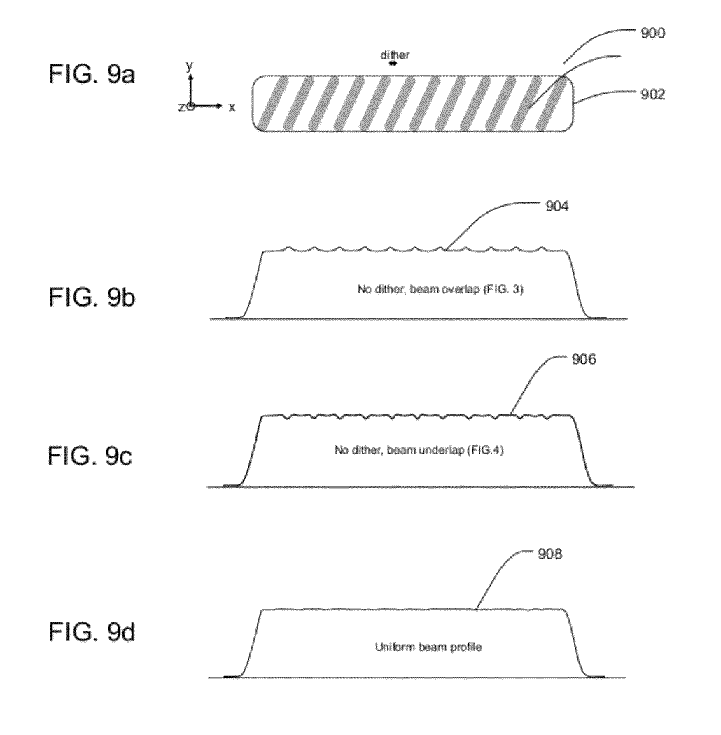

Embodiments of the present invention may also provide a diffuser to diffuse mass analyzed beamlets together. In the example of FIG. 1, a dither magnet 124 is provided to smooth the beamlets of mass analyzed ions 112a to provide a more uniform beam when scanned across the workpiece, as discussed further below with respect to FIGS. 9a-9d.

Accordingly, ion implanter 100 provides a compact ion beam architecture than provides high current of a desired species over large areas, such as large workpieces, while still providing a mass analyzed beam to the workpiece in which unwanted ion species are screened out before impacting the workpiece. In some particular embodiments, the ion implanter operates to screen lighter ions from heavier ions that are transmitted to a workpiece.

With reference also to FIG. 1, FIGS. 3 and 4 present a side plan view in the x-y plane of additional exemplary extraction plates 306 and 406, respectively, that may be used in assembly 104. Extraction plates 306 and 406 may each include a plurality of elongated apertures 310 whose long axes are generally parallel. As depicted, the long direction L_{A} is substantially longer than the width d of apertures 310. A main difference between plates 306 and 406 is the difference in (non-zero) angle that is formed by the long axes of the apertures with respect to the y-direction.

Referring to both FIGS. 3 and 4, when considered as a whole, apertures 310 and 410 define a larger area or beam footprint (or “beam cross-section”) 308 and 408, respectively, whose length is given by L1 and L2, respectively, and whose width is given by W. In both embodiments, each aperture 310, 410 extends across the full footprint length, such that the footprint length L1, L2 is comparable to the length L_{A} of a single aperture, and the width W is equal to the sum of widths d of individual apertures added to the sum of the spacings S. It will be appreciated that the beam cross-section (footprint) defined by the assemblage of individual apertures is substantially the same as the cross-section of a unitary ion beam that may be formed by mixing of the individual beamlets if the trajectories of ions in the individual beamlets overlap sufficiently to merge. However, the terms “beam footprint” or “beam cross-section” may also be used herein to refer to the general area 308 defined by the assemblage of apertures or the ion beamlets derived therefrom, even when the beamlets remain separated.

In operation, aperture plates 306, 406 may be used as an electrode to extract ions from ion source 102 and form a plurality of beamlets (not shown) as described above with respect to FIGS. 1, 2. The beamlets formed thereby may be mass analyzed as separate beamlets and then subsequently transmitted as separate beamlets to a workpiece or mixed together to define a uniform beam whose cross-section corresponds to beam footprint 308.

In some embodiments, the beam footprint length L1, L2 may range from a several millimeters to about 20 centimeters and the width W may range from a few centimeters to about 1 meter or so. In one example, the width W may be increased by providing a longer aperture plate containing more apertures having the same width d and length L_{A}. In operation, therefore, aperture plates 306, 406 may be used to produce ribbon beams whose width (corresponding to the dimension W) is on the order of one meter. Such beams may be scanned with respect to a substrate platen, for example, in the y-direction to provide implantation over a large area.

The arrangement of aperture plates 306, 406 provides the further advantage in that a continuous beam current may be provided to a workpiece even when separate beamlets impact a workpiece. This may be accomplished by scanning the workpiece in the y-direction with respect to the aperture plates. For example, the spacing S of apertures 310 of aperture plate 306, their length L_{A}, and angle with respect to the y-direction are sufficient to define an overlap region O in the x-direction. Thus, when scanned in the y-direction, the pattern of beamlets (ions) formed from the angled apertures may form a continuous overlapping beam current at a workpiece. The angle formed by apertures 310 in aperture plate 406 is less than that in aperture plate 306, such that a slight beamlet underlap U is defined. However, when a workpiece is scanned in the y-direction with respect to aperture plate 406, the beamlet divergence after exiting the apertures 310, as well as the use of a dithering magnet (described further below with respect to FIGS. 9a-9d) may help provide a continuous and uniform beam current in the x-direction to a workpiece.

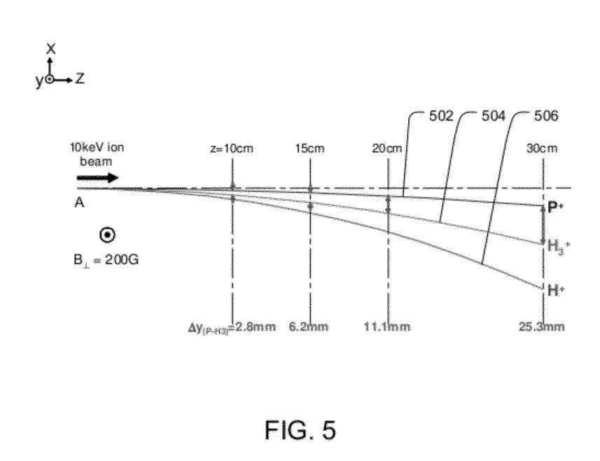

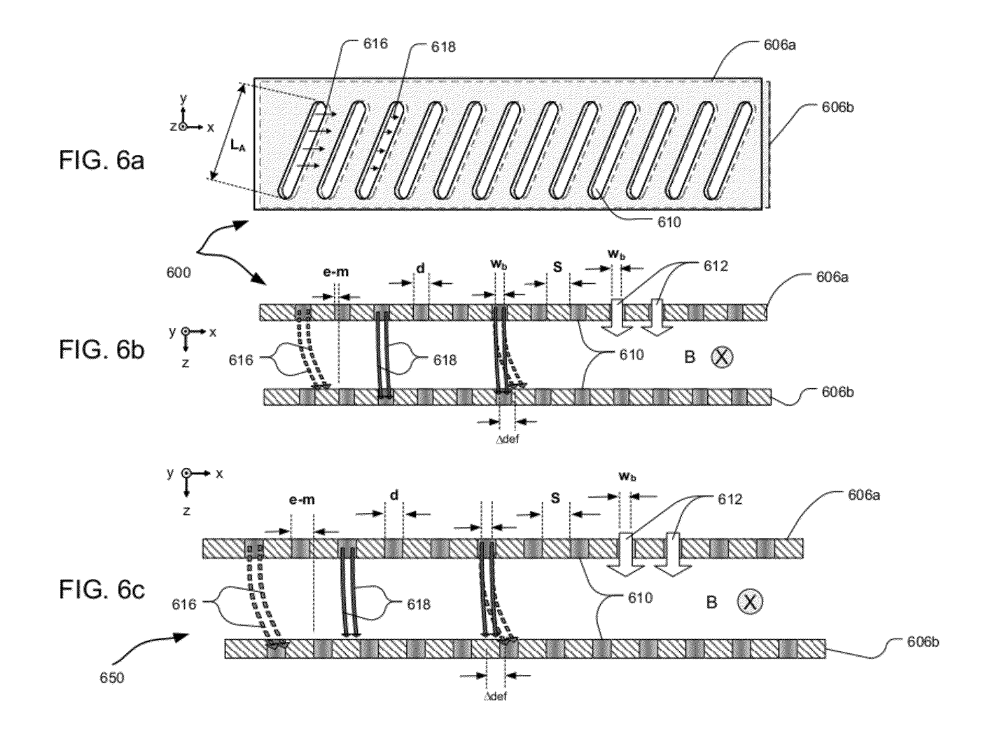

Another advantage of the ion beam implanter arrangements of the present disclosure is that the compact, high ion current geometry of PLAD-style systems is provided together with a mass analysis capability. In particular, the present embodiments provide ion beams having a width up to about one meter that may be conveniently mass analyzed by providing ion deflections on the order of as little as a few millimeters. As detailed further below with respect to FIGS. 5 and 6a-c, this is accomplished by initially partitioning ions from an ion source into a plurality of narrow beamlets using a plurality of narrow apertures. Once the narrow beamlets are defined, the unwanted ions require only a small lateral deflection on the order of the spacing between the narrow apertures in order to be effectively screened by an analysis plate. This small lateral deflection may be provided by an analyzing magnet that only need produce a moderate magnetic field strength on the order of one hundred or hundreds of Gauss.

Embodiments may specifically provide a mass analyzed beam for implanting dopant species into a workpiece, such as a solar cell or an integrated circuit substrate. The ion species may be derived from a plasma source that may contain, in addition to the dopant species, unwanted ion species, such as hydrogen ions (Hₓ⁺). FIG. 5 presents the results of calculations of trajectories of 10 keV ions subject to a moderate magnetic field of 200 Gauss strength that is arranged orthogonal to the initial beam trajectory. Referring also to FIG. 1, point A may represent the point at which ions from beamlets 112 initially enter magnetic analyzer 114 at which point their direction of propagation (principal beam axis) is parallel to the z-direction. The example of FIG. 5 shows the trajectory of some typical ion species that may be present in a plasma used to provide phosphorous doping to a workpiece. As is evident, H⁺ ions 506 and H₃⁺ ions 504 are deflected to a much larger extent than are P⁺ ions 502. For example, the difference in lateral deflection along the x-direction between H₃⁺ ions and P⁺ ions is about 6.2 mm at a point along the z-direction that is 15 cm from A.

Continuing with the example of FIG. 5, embodiments of the ion implantation system may be arranged to selectively block unwanted ions, such as Hₓ⁺ (x=1, 2, 3) while permitting desired ions, such as P⁺ to pass through to a workpiece. FIGS. 6a and 6b present a side plan view and top cross-sectional view of an exemplary mass analysis system 600 including an extraction aperture plate 606a and a mass analysis aperture plate (or mass analysis plate) 606b. As illustrated, and in some embodiments, the plates may include a similar configuration of apertures and have similar overall dimensions in the x- and y-directions.

In operation, extraction aperture plate 606 of system 600 may extract ions as unanalyzed ion beamlets 612 that pass through apertures 610 substantially parallel to the direction z, as illustrated in FIG. 6b. In one example, an extraction potential may be applied to plate 606a that defines beamlets 612, whose width w_{b} may be less than the width d of apertures 610. The unanalyzed beamlets 612 may include both light ions 616 and heavy ions 618. As illustrated in FIG. 6b, a magnetic field B disposed between plates 606a and 606b creates field lines perpendicular to the trajectories of ion beamlets 612, which creates a force to deflect ions in the x-direction as the ions traverse between plates 606a and 606b. For clarity, FIG. 6b also depicts separately and together the light ion 616 and heavy ion 618 components that constitute at least a portion of beamlets 612. For example, light ions 616 may represent Hₓ⁺ (x=1, 2, 3) ions and heavy ions 618 may represent P⁺ ions. The trajectories of heavy ions 618 are slightly deflected, while the trajectories of light ions 616 are more strongly deflected in the x-direction, such that ions 616 are blocked by the top surface of mass analysis plate 606b, while ions 618 pass through apertures 610 in mass analysis plate 606b.

The differential deflection Δdef may be defined as the difference in deflection in the x-direction between that experienced by the lighter ions and that experienced by the heavier ions while the ions traverse between extraction plate 606a and mass analysis plate 606b. As shown in FIG. 5, the value of Δdef may be varied by varying the distance through which the ions travel through an orthogonal magnetic field along the z-direction, as well as the difference between the masses (or mass/charge ratios) of the ions in question. It will also be apparent to those of ordinary skill that Δdef additionally depends upon the ion energy and strength of magnetic analyzing field.

In the example shown, an offset e-m between extraction and mass analysis apertures is provided in the x-direction, which may help ensure that the entire width w_{b} of sub-beams of light ions 616 is blocked, while the entire width w_{b} of sub-beams of heavy ions 618 passes through the lower apertures 610. In some embodiments, the spacing S between apertures may be greater than or equal to the aperture width d, to help ensure that the beamlet width w_{b} of deflected ions 616 is not greater than the spacing between apertures, which might permit at least some deflected ions 616 to pass through at least one of a pair of adjacent apertures.

Advantageously, as further depicted in FIG. 6b, embodiments of system 600 are especially effective when Δdef is greater than or equal to beamwidth w_{b}, thereby producing no spatial overlap in sub-beams 616 and 618 at the surface of mass analysis plate 606b. This allows mass analysis plate 606b to transmit the entire width of a sub-beam of desired ions while screening the unwanted sub-beam.

In embodiments, the total distance traversed by ion beamlets between aperture plates 606a and 606b may be on the order of 15 cm, for example, between about 5 cm to about 50 cm, depending on the required mass resolution. In one particular example, for a mass analyzed 10 keV phosphorous ion beam that is stripped of Hₓ⁺ (x=1, 2, 3) ions, a differential deflection Δdef of about 6 mm may be produced for a 200 Gauss, 15 cm long orthogonal B field (along the z-direction). This, in turn, requires a separation between plates 606a and 606b of at least 15 cm to allow room for a magnet assembly to be placed therebetween to provide the required 15 cm long B field. Accordingly, an aperture arrangement whose extraction assembly plate is separated from the mass analysis plate by at least 15 cm and whose apertures 610 produce beamlets 612 having widths w_{b} less than about 6 mm may be effective in producing a 10 keV phosphorous beam in which a large fraction of Hₓ⁺ (x=1, 2, 3) contamination is removed using a 200 Gauss magnetic field. This, in turn may require arranging the width d of slots 610 to be about 10 mm or smaller.

In other embodiments, extraction aperture plate 606a and mass analysis plate 606b may be configured to selectively block higher mass ions, as depicted in arrangement 650 of FIG. 6c. In this embodiment, the e-m offset is relatively larger than in FIG. 6b such that lighter ions 616 are deflected into an aperture 610 provided in mass analysis plate 606b, while heavier ions 618 are blocked.

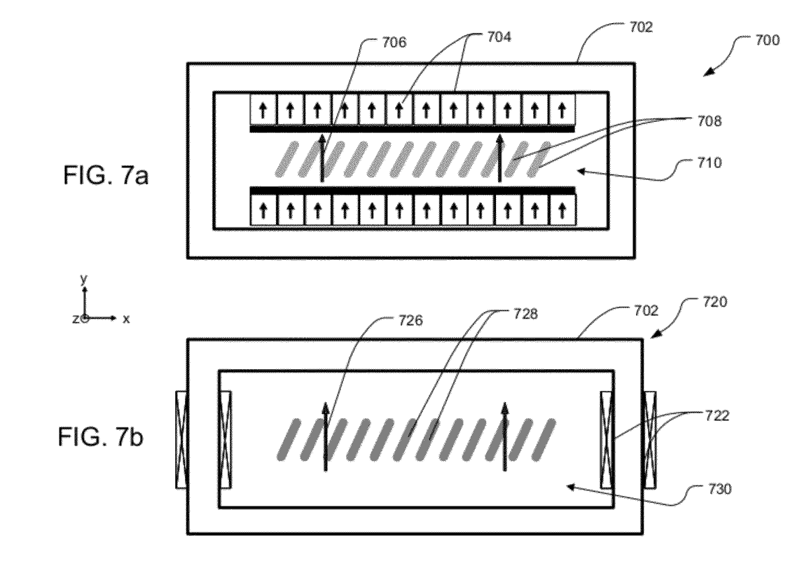

FIGS. 7a and 7b are side plan views that present details of respective magnetic assemblies 700 and 720, which may act as magnetic analyzers according to alternative embodiments of the disclosure. Magnetic assembly 700 presents a housing 702 that contains two separated sets of permanent magnets 704 whose poles are aligned generally in a common direction parallel to the y-axis, so as to produce a magnetic (B) field aligned in the y-direction. This field may produce a deflection force on charged particles that pass through gap 710 between magnets 704. For example, beamlets 708 may be deflected in the x-direction while traveling through gap 710 in the z-direction (out of page). In order to screen the magnetic field from ion source and other components, housing 702 may comprise a low carbon steel, or similar material.

In the embodiment of FIG. 7b, a pair of opposed electromagnets 722 are used to produce B field 726, again aligned parallel to the y-axis, such that a deflection force in the x-direction is produced for beamlets 728 traveling through gap 730 in the z-direction. Referring again to FIG. 1, the height of magnet assemblies 700, 720 (that is, the dimension in the z-direction) may be arranged to provide a desired horizontal deflection for ions of a given energy. For example, it may be desirable to employ a relatively weaker magnetic field so as to provide less interference with other components of an ion implantation system. Accordingly, the magnet assemblies may be designed with a relatively greater height so as to provide a longer distance through which ions experience an orthogonal magnetic force to compensate for the relatively weaker field.

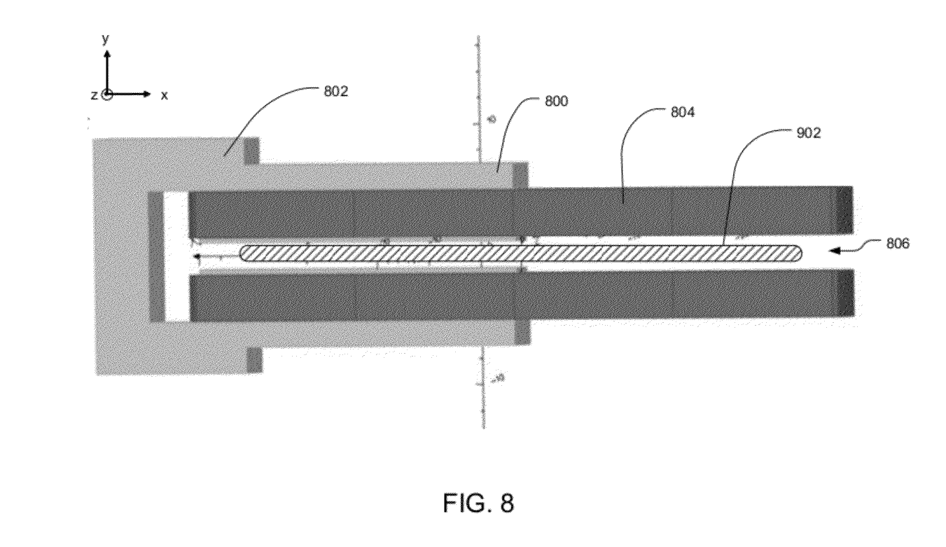

FIG. 8 depicts details of an exemplary dithering magnet 800 that may be used to mix analyzed ions after the ions exit a mass analysis plate. Magnet 800 is configured to impart a deflection into ions that pass through a gap 806 between pole pieces 804 that are spaced using yoke 802. Referring also to FIG. 9a, an exemplary group of mass analyzed beamlets 900 are depicted, which may represent a set of beamlets of a preferred ion species after passing through a mass analysis aperture, as described above with respect to FIGS. 6a, 6b. The beamlets 900 define a beam footprint 902 whose dimensions in the x- and y-directions (W×L) may be configured to allow the entire beam footprint of beamlets 902 to pass between pole pieces 804, as depicted in FIG. 8.

In one example, the dithering magnet may generate an oscillating magnetic field with a triangular sawtooth waveform that can smooth out the beamlets 900. In order to facilitate improved beam uniformity, a dither magnet may be disposed immediately adjacent to a mass analysis plate, as depicted in FIG. 1, thus providing a greater distance for mixing of beamlets to occur before reaching the workpiece.

FIGS. 9b and 9c depict respective cross-sectional profiles 904 and 906, respectively, of ion current at a workpiece surface as a function of position along the x-direction for beamlets in which no dithering magnet is used and respective beamlet overlap or underlap is present in the x-direction. Thus, the ion current profiles of FIGS. 9b and 9c may correspond to beamlets passing through an analysis plate configured as in FIGS. 3 and 4, respectively.

FIG. 9d presents a beam current profile 908 for beamlets in which a dithering magnet is employed to smooth the beamlets. The smoothed beamlets exhibit a uniform current density, as compared to the fluctuation in current density apparent in the unsmoothed beamlets of FIGS. 9b and 9c.

In other embodiments, the spacing, length and angle of slots in an analysis plate may be such that a uniform beam current is produced when a workpiece is scanned in the y-direction without the use of a dithering magnet.

In summary, the inventive ion implantation system of the present disclosure provides a mass analyzed ion beam in a compact geometry that facilitates the ability to produce high ion currents at the workpiece due to the proximity of ion source and workpiece. Moreover, the extraction plate architecture that provides an analyzed beam is scalable to larger beam dimensions without the need to scale features such as magnetic field strength. In other words, the local deflection distance required to provide a mass analyzed beam is independent of the overall beam dimensions. Exemplary ion implantation systems of the present disclosure may be used, for example, where high throughput, high current implantation is required using a single ion species and where only a single ion energy is employed. In such a case, a permanent magnet configuration that produces an optimized and unchanging magnetic field strength may be used in conjunction with a fixed configuration of extraction and mass analysis plates. Moreover, even if beam energy is to be varied to some extent, a permanent magnet configuration may be used, by accommodating variations in energy by adjusting the relative positions in x-direction of extraction aperture slots with respect to analysis slots (see FIG. 606b.) However, other exemplary ion implantation systems may provide more flexibility in choice of ion species and energies, for example, those that employ electromagnets whose field strength can be varied to produce the required deflection distance based upon the ion mass(es) and energies.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. For example, embodiments disclosed hereinabove have generally depicted the scenario in which one species of heavier ions is transmitted by a mass analysis plate, while one species of lighter ions is blocked. However, more than one ion species may be blocked in other embodiments by the appropriate choice of parameters including aperture width, aperture separation, magnetic field strength, ion energy, and the like. In addition, embodiments of this disclosure include arrangements in which only partial screening of unwanted ion species may occur. In other words, exemplary operating parameters such as ion energy, magnetic field strength and aperture arrangements may permit a fraction of a total species of unwanted ions to propagate to a workpiece (as well as a fraction of desired species to be blocked) in cases where exposure of the workpiece to that fraction of unwanted species is tolerable. Moreover, in further embodiments, the individual apertures of the extraction plates and mass analysis plates need not be elongated nor have any particular shape.

Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A system for producing a mass analyzed ion beam for implanting into a workpiece, comprising:
an ion extraction plate having a set of apertures configured to extract ions from an ion source to form a plurality of beamlets;
a magnetic analyzer configured to provide a magnetic field to deflect ions in the beamlets in a first direction that is generally perpendicular to a principle axis of the beamlets;
a mass analysis plate having a set of apertures wherein first ion species having a first mass/charge ratio are transmitted through the mass analysis plate and second ion species having a second mass/charge ratio are blocked by the mass analysis plate; and
a workpiece holder configured to move with respect to the mass analysis plate in a second direction perpendicular to the first direction, wherein a pattern of ions transmitted through the mass analysis plate forms a continuous ion beam current along the first direction at the workpiece.

2. The system of claim 1, wherein the set of apertures in the mass analysis plate defines a pattern substantially similar to that defined by the set of apertures in the ion extraction plate.

3. The system of claim 1, further comprising a set of electrode plates arranged in series with the extraction plate, the set of electrode plates each having an aperture arrangement similar to that of the extraction plate, wherein the set of electrode plates and extraction plate comprise an extraction assembly.

4. The system of claim 1, wherein the first ion species has a greater mass/charge ratio that the second ion species, the extraction plate and the mass analysis plate being mutually arranged wherein the mass analysis blocks a greater fraction of the second ion species than the first ion species.

5. The system of claim 2, the ion extraction plate having a set of apertures that mutually define an elongated beam footprint, the apertures of the mass analysis plate defined by an aperture width parallel to a long axis of the elongated beam footprint, wherein the first and second ion species are deflected respective first and second deflection distances in a direction parallel to the aperture width, the difference in deflection distances being at least as great as the aperture width.

6. The system of claim 1, further comprising a diffuser disposed between the mass analysis slit and the workpiece so as to mix the mass analyzed beamlets wherein the continuous ion beam current exhibits a uniform profile in the first direction.

7. The system of claim 6, wherein the diffuser comprises a dithering magnet configured with a triangular sawtooth waveform.

8. The system of claim 1, wherein the magnetic analyzer comprises a metal housing configured to shield the magnetic field from external components.

9. The system of claim 8, wherein the magnetic analyzer comprises a first and second set of permanent magnets disposed within the housing and defining a gap to transmit the beamlets.

10. The system of claim 8, wherein the magnetic analyzer comprises a pair of electromagnets coupled on opposite sides to the metal housing.

11. The system of claim 1, the ion extraction plate having a set of apertures that mutually define an elongated beam footprint, the sets of extraction plate apertures and mass analysis plate apertures being elongated wherein their long axes form a non-zero angle with respect to a long axis of the elongated beam footprint.

12. The system of claim 5, wherein the set of apertures in the mass analysis plate is offset in the first direction with respect to the set of apertures of the extraction plate, wherein the offset is about equal to the first deflection distance.

13. A method of providing a large area mass analyzed ion beam to a substrate, comprising:
forming unanalyzed beamlets that define a beam footprint having a long axis, said beamlets formed by extracting ions from an ion source through a plurality of slots in an extraction plate;
deflecting a first and second group of ions in the unanalyzed beamlets over respective first and a second deflection distances in a first direction generally parallel to the long axis of the beam footprint with a magnetic field;
blocking the second group of ions with an analysis plate; and
translating the substrate with respect to the analysis plate in a second direction perpendicular to the first direction, wherein a pattern of ions transmitted through the analysis plate forms a continuous ion beam current along the first direction at the substrate.

14. The method of claim 13, wherein the mass analysis plate is configured with an arrangement of apertures substantially similar to that in the ion extraction plate.

15. The method of claim 13, wherein the extraction plate and mass analysis plate are mutually arranged to transmit a larger fraction of heavier ions through the mass analysis plate than a fraction of lighter ions transmitted through the mass analysis plate.

16. The method of claim 13, further comprising arranging the apertures of the mass analysis plate with an offset in the first direction with respect to the apertures of the extraction plate, wherein the offset is about equal to the first deflection distance.

17. The method of claim 13, further comprising providing a diffuser disposed between the mass analysis slit and the workpiece wherein the continuous ion beam exhibits a uniform current profile in the first direction.

18. The method of claim 17, wherein the diffuser comprises a dithering magnet configured to produce a motion through a distance on the order of a spacing between apertures in the mass analysis plate.

19. The method of claim 13, the apertures of the mass analysis plate defined by an aperture width that is parallel to the long axis of the beam footprint, wherein a difference in the first and second deflection distances is at least as great as the aperture width.

20. An ion implantation system, comprising:
an ion source that produces a first ion species having a first mass/charge ratio and a second ion species having a second mass/charge ratio;
an extraction plate having a plurality of elongated apertures configured to extract, from the ion source, a corresponding plurality of elongated beamlets having a long axis, wherein the plurality of beamlets comprise an elongated beam footprint having a long axis generally at a non-zero angle to the long axis of the beamlets;
a magnet assembly having a gap configured to produce a deflection force when the plurality of beamlets pass therethrough, wherein, after traveling through the magnet assembly, the first and second ion species are deflected in a direction parallel to the long axis of the elongated beam footprint, a respective first and second distance; and
a mass analysis plate having a set of apertures arranged so as to transmit the first ion species to a workpiece and to block the second ion species.

21. The system of claim 20, further comprising a dithering magnet disposed between the mass analysis plate and the workpiece and being configured to produce a dithering motion in a plane perpendicular to a direction of propagation of the transmitted first ion species.
